(19) United States
(12) Patent Application Publication
(10) Pub. No.: US 2017/0326867 A1
(43) Pub. Date: Nov. 16, 2017

(54) HYBRID MICRO-MANUFACTURING

(71) Applicant: Resonetics, LLC, Kettering, OH (US)

(72) Inventors: Kevin Hartke, Tipp City, OH (US); John Middendorf, Springfield, OH (US); Jared Speltz, Washington Township, OH (US)

(21) Appl. No.: 15/592,121

(22) Filed: May 10, 2017

Related U.S. Application Data
(60) Provisional application No. 62/334,121, filed on May 10, 2016.
(60) Provisional application No. 62/466,745, filed on Mar. 3, 2017.

(51) Int. Cl. B33Y 10/00; B29C 65/00; B33Y 30/00; B33Y 80/00

(52) U.S. Cl. CPC B33Y 10/00; B29C 66/80; B33Y 30/00; B29C 66/0242; B33Y 80/00

(57) ABSTRACT

A hybrid manufacturing machine comprises a workpiece platform, a powder delivery system, and a scan head. The powder delivery system delivers powder from a powder storage system to the workpiece platform. A controller executes a program to perform a manufacturing operation on a part situated on the workpiece platform based upon a three-dimensional representation of the part. The scan head is controlled by the controller to emit a first energy beam that implements an additive process on the part, and a second energy beam that implements a material manipulation process on the part. The hybrid manufacturing machine can also include a measurement device, e.g., a laser profilometer, camera, microscope, etc. Under this configuration, the controller can control the scan head to emit the second energy beam to perform the material manipulation operation as a micro-machining operation to remove structure from the part based upon an output from the measurement device.

### CROSS REFERENCE TO RELATED APPLICATIONS

This application claims the benefit of U.S. Provisional Patent Application Ser. No. 62/334,121, filed May 10, 2016, entitled HYBRID LASER MICRO-MANUFACTURING, the disclosure of which is hereby incorporated herein by reference. This application also claims the benefit of U.S. Provisional Patent Application Ser. No. 62/466,745, filed Mar. 3, 2017, entitled HYBRID MICRO-MANUFACTURING, the disclosure of which is also hereby incorporated herein by reference.

### BACKGROUND

Various aspects of the present disclosure relate generally to hybrid manufacturing, and more particularly, to systems and methods of combining additive manufacturing with material manipulation, which can include subtractive manufacturing, micro-machining, re-melting, ablation, material property modification, material surface modification, material position modification, a combination thereof, etc.

Additive manufacturing occupies a rapidly growing technology space that is centered upon the concept of fabricating a three-dimensional object by building up the object layer-by-layer of material. For instance, in selective laser sintering, a layer of powder is spread over a part bed. A computer-aided design file is then used to control a laser to trace the laser's beam over a surface of the powder in the part bed. As a result, the laser's beam selectively melts and bonds the powder to form a cross-section of a desired part. The above-process is repeated layer-by-layer until a complete instance of the desired part is built.

Subtractive manufacturing on the other hand, is centered upon the concept of selectively removing material from a stock of starting material until a complete instance of a desired part remains. Subtractive manufacturing is carried out through one or more machining processes, which traditionally include turning, drilling, and milling.

### BRIEF SUMMARY

According to aspects of the present disclosure, a hybrid manufacturing machine comprises a workpiece platform, a powder delivery system, and a scan head. In brief, the workpiece platform forms a support upon which a part is built, repaired or modified. The powder delivery system selectively supplies powder to the workpiece platform. The scan head is controlled to emit a first energy beam that implements an additive process on the part, and a second energy beam that implements a material manipulation process on the part.

In operation, a controller (which can be part of the hybrid manufacturing machine or provided as an external control source) executes a program to perform a manufacturing operation on a part situated on the workpiece platform. Typically, a manufacturing operation can be carried out to build a new part, or to repair or modify an existing part. Moreover, the manufacturing operation is based upon a three-dimensional representation of the part, which is stored in memory accessible by the controller. In this regard, the controller controls the powder delivery system to deliver powder from a powder storage system to the workpiece platform. Additionally, the controller implements the additive process by controlling the scan head to emit the first energy beam according to the program executed by the controller to selectively melt powder proximate to a top surface of the workpiece platform to add structure to the part.

Also, the controller implements the material manipulation process by controlling the scan head to emit the second energy beam to manipulate material, which may be on or otherwise added to the part, located in the machine, e.g., on the workpiece platform, etc. For instance, material manipulation can comprise subtractive manufacturing (e.g., to remove surface defects and/or sub-surface defects), micro-machining, re-melting, ablation, material property modification (e.g., to add or remove residual stress), material surface modification (e.g., to modify material property, to define features to improve bonding, etc.), material position modification (e.g., to move powder to a desired location), a combination thereof, etc., as will be described more fully herein.

The hybrid manufacturing machine can also include a measurement device, e.g., a laser profilometer, camera, microscope, etc. Under this configuration, the controller implements the material manipulation process to remove structure from the part based upon an output from the measurement device. For instance, by comparing a measurement of the actual part against the three-dimensional representation, errors in one or more layers can be detected, and corrections can be implemented, e.g., via re-melting, micro-machining, repeating part of an additive operation, etc., to ensure precision throughout the entire build process.

According to further aspects of the present disclosure, a process of implementing hybrid manufacturing in a single machine, comprises repeatedly performing a sequence of machining operations. The repeated machine operations comprise controlling, by a controller, a first energy beam to selectively melt at least one layer of powder to add structure onto a part according to a three-dimensional representation of the part. The repeated machine operations also comprise determining whether a build manipulation is required. The repeated machine operations still further comprise controlling, by the controller, a second energy beam to perform a material manipulation when the determination indicates that a build modification is required. The build modification can be carried out by executing any one or more of the material manipulation processes discussed more fully herein.

The repeated machine operations can optionally include measuring, by a measurement device, a surface of the part after selectively melting at least one layer. In this regard, the process of determining whether a build correction is required can be based upon results of the measurement, e.g., by comparing the measurement of the actual part to a corresponding slice of the three-dimensional representation to detect errors in the part.

### BRIEF DESCRIPTION OF THE SEVERAL VIEWS OF THE DRAWINGS

FIG. 1 is a block diagram of a hybrid laser micro-manufacturing machine using a powder bed system, according to aspects of the present disclosure herein;

FIG. 2 is an alternative implementation of a hybrid laser micro-manufacturing machine using a powder fed system, according to aspects of the present disclosure herein;

FIG. 3 is a block diagram of an example implementation a scan head for the hybrid laser micro-manufacturing machine of FIG. 1 or FIG. 2;

FIG. 4 is a block diagram of an alternative example implementation of a scan head for the hybrid laser micro-manufacturing machine of FIG. 1 or FIG. 2;

FIG. 5 is a flow chart of an example implementation of the hybrid laser micro-manufacturing machines described more fully herein; and

FIG. 6 is a block diagram of a processing device capable of implementing the controller described more fully herein.

### DETAILED DESCRIPTION

Aspects of the present disclosure combine additive manufacturing techniques with material manipulation (e.g., which can include by way of example, subtractive manufacturing, micro-machining, re-melting, ablation, material property modification, material surface modification, material position modification, a combination thereof, etc.), into an integrated process. In example implementations, laser-based material manipulation is integrated with a laser-based additive manufacturing system to yield a hybrid laser micro-manufacturing machine suitable for producing a vast array of parts.

In this regard, material manipulation operations can be implemented while a build is in-process to correct deviations in the part and/or to modify properties of the part as the part is being built. As such, a part build using the hybrid laser micro-manufacturing machine herein is dimensionally precise and can have material properties that vary according to defined specifications.

According to aspects of the present disclosure, material modifications can include one or more of: correcting deviations in a part being built (surface or subsurface) relative to a defined specification such as a three-dimensional representation of the part, e.g., to a desired tolerance; finish can be improved; material properties can be altered (e.g., to modify grain direction, a stress property, hardness, brittleness, a compressive characteristic, a sheer characteristic, an elastic property, ductility, etc.); surface features can be implemented (e.g., to improve bonds between layers of different material, or to effect desired structural characteristics); build time can be improved; and parts can be produced of higher quality than that of conventional additive and/or subtractive processes. Moreover, by using material manipulation to control material properties, parts can be built that were not otherwise possible. Yet further, the material manipulation herein facilitates the ability to perform finishing operations that would not otherwise be possible, e.g., to machine an internal feature of a part.

As noted more fully herein, the use of laser-based material manipulation provides distinct advantages over more traditional subtractive machining approaches, such milling techniques that use conventional computer numerical control (CNC) machines. However, the techniques herein can be used in lieu of, or in combination with, traditional subtractive machining approaches.

Aspects of the present disclosure can perform one or more material manipulation(s) on every layer, at any other interval, pattern, etc., or when determined to be necessary, e.g., based upon measurements, rules, preprogrammed logic, specifications in a corresponding control file, etc. For instance, a decision to micro-machine may be static, e.g., every n layers, where n is a positive integer.

In other implementations, a decision to micro-machine may be dynamic, e.g., based upon an inspection result. In this regard, a measurement device such as a profilometer may be used to inspect the part as the part is being built. The inspection may likewise occur every layer. In other example implementations, the decision to inspect may be static, e.g., every n layers, where n is a positive integer, or dynamic, based upon the materials, processing conditions, geometry of the part, processing parameters, etc., as described more fully herein.

Moreover, material manipulations can be carried out in any combination, as needed. For instance, a first layer may require laser micro-machining to remove material that deviates from a predetermined tolerance. However, a second layer may require both material surface modification (e.g., to prepare the surface for bonding with a new/different material) and to perform laser micromachining, etc. That is, any combination of material manipulations can be carried for each layer. Moreover, material manipulations may be based upon programmable parameters (e.g., a control file that specifies a specific material properties, e.g., surface hardness or stress profile), or material manipulations can be based upon measurement of the part being manufactured (or a combination of program control and measurement).

### Powder Bed Example Configuration

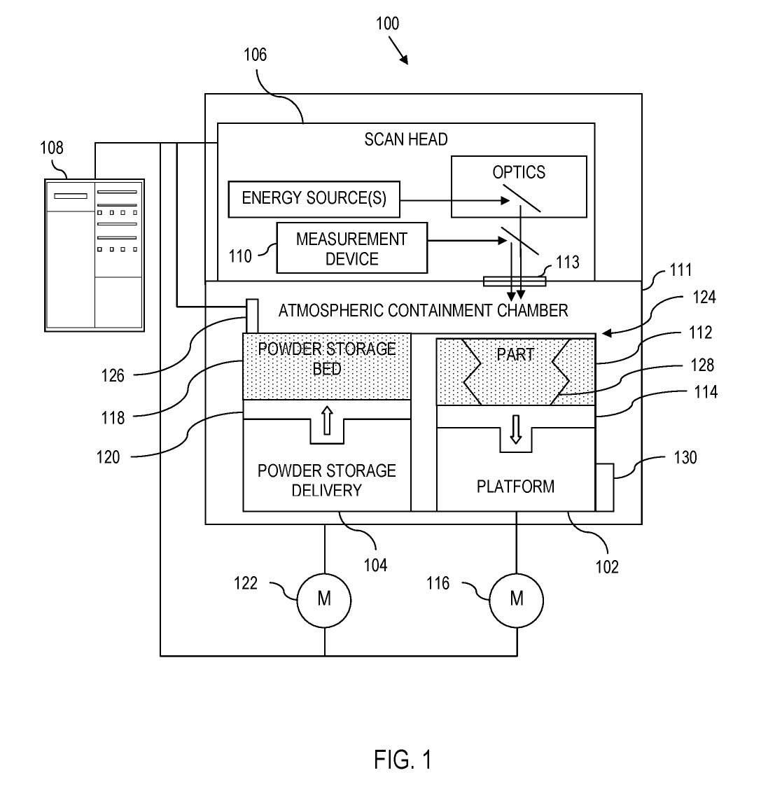

Referring to drawings and in particular FIG. 1, a hybrid laser micro-manufacturing machine 100 is illustrated. The hybrid laser micro-manufacturing machine 100 comprises in general, a workpiece platform 102, a powder delivery system 104, and a scan head 106. In example configurations, the hybrid laser micro-manufacturing machine 100 is connected to an external controller 108, e.g., a computer. In alternative configurations, the controller 108 is built into the hybrid laser micro-manufacturing machine 100. The hybrid laser micro-manufacturing machine 100 can also include an optional measurement device 110, as will be described in greater detail herein. Although the measurement device 110 is shown schematically within the scan head 106, other implementations can implement the measurement device 110 outside the scan head 106. Moreover, although the measurement device 110 is shown as a single device, in practice there can be multiple measurement devices, each implemented using the same or different technology, and each within the scan head 106 or external to the scan head 106.

In some embodiments, the controller is driven by a CAD model defined by slices where each slice defines one or more actions. Each action can define operations that affect which laser beam to use, how the material is to be manipulated, etc.

Machine Chamber

In illustrative example implementations, the workpiece platform 102 of the hybrid laser micro-manufacturing machine 100 is housed in an atmospheric containment chamber 111. In alternative implementations, the powder delivery system 104 and/or the scan head 106 are also contained within the atmospheric containment chamber 111. Regardless, the atmospheric containment chamber 111 includes an inert gas intake and an inert gas exhaust. The controller 108 controls the atmospheric containment chamber 111 to allow oxygen to be purged from the system, thus enabling the powder to be processed in an inert atmosphere. Electrical wires are fed through air tights ports in a housing of the atmospheric containment chamber 111. Moreover, in an example implementation where the scan head is positioned external to the atmospheric containment chamber 111, an emitted energy beam from the scan head 106 is directed towards the workpiece platform 102 through a window 113, e.g., implemented from optical glass or quartz.

Powder System

In an example implementation, the workpiece platform 102 and the powder delivery system 104 are integrated into a powder spreading mechanism implemented as a two-platter system. A first platter, also referred to as a build platter, includes the workpiece platform 102, and thus serves as a build area. The second platter, also referred to as a supply platter, includes the powder delivery system 104, and serves as a reservoir of supply powder.

More particularly, the workpiece platform 102 of the build platter includes a powder bed 112 that sits over a support plate 114. The support plate 114 is coupled to a first motor 116 (e.g., a micro-stepper motor), which is controlled by the controller 108 to selectively raise and lower the support plate 114, and thus correspondingly raising and lowering the powder bed 112.

Similarly, the powder delivery system 104 of the supply platter includes a powder storage bed 118 that sits over a delivery plate 120. The delivery plate 120 is coupled to a second motor 122 (e.g., a micro-stepper motor), which is controlled by the controller 108 to selectively raise and lower the delivery plate 120, thus correspondingly raising and lowering the powder storage bed 118.

In an example configuration of the build platter, the first motor 116 is mounted on the exterior of the powder spreading mechanism. The first motor 116 has a shaft coupled into an axle that stretches underneath the support plate 114. The axle in this example, holds a pinion. The support plate 114 is implemented as a flat plate. A corresponding support bar mounts into a bottom of the support plate 114, and extends down through a corresponding internal cavity in a frame of the powder spreading mechanism. The support bar holds a guide rail, which fits into an associated carriage mounted into the frame. The rail/carriage helps to ensure the support bar remains vertical, keeping the support plate 114 horizontal and parallel with a powder spreading plane. The support bar is also coupled to a rack, which pairs with the pinion associated with the motor 116. As the motor 116 rotates, the axle and pinion rotates, which moves the rack and support plate 114 up and down.

Keeping with the above-example, the supply platter can have an analogous assembly to the build patter. In this example, the second motor 122 is also mounted on the exterior of the powder spreading mechanism. The second motor 122 has a shaft coupled into an axle that stretches underneath the delivery plate 120, which holds a corresponding pinion. The delivery plate 120 is also implemented as a flat plate. In a manner analogous to that above, a corresponding support bar mounts into a bottom of the delivery plate 120, and extends down through an associated internal cavity in the frame of the powder spreading mechanism. The support bar mounted into the bottom of the delivery plate 120 holds a guide rail, which fits into an associated carriage mounted into the frame. This rail/carriage helps to ensure the support bar remains vertical, keeping the delivery plate 120 horizontal and parallel with a powder spreading plane. The support bar mounted to the delivery plate 120 is further coupled to a rack, which pairs with the pinion associated with the motor 122. As the motor 122 rotates, the axle and pinion rotates, which moves the rack and delivery plate 120 up and down.

Other mechanisms can be utilized to effect movement of the platters, and hence the support plate 114 of the workpiece platform 102, and the delivery plate 120 of the powder delivery system 104.

Before the initiation of a working operation, the controller 108 controls the first motor 116 to traverse the support plate 114 to a raised position within the workpiece platform 102. Likewise, the controller 108 controls the second motor 122 to traverse the delivery plate 120 to a low position within the powder delivery system 104, and the powder storage bed 118 is filled with powder.

Thus, the supply platter starts low, with the powder storage bed 118, e.g., defined by a cavity of the supply platter, filled with stock powder or combination of powders (typically metallic, but the system allows for any powder, including non-metallic powders to be processed). Correspondingly, the build platter starts high, with the powder bed 112, defined by the cavity of the build platter, initially empty, or otherwise containing a starting or base layer of powder.

The powder delivery system 104 delivers powder to the workpiece platform 102 by spreading a layer of powder across to a top surface of the powder bed 112. The thickness of the layer will vary depending upon the application. However, an example range is approximately 20 microns to approximately 100 microns thick. For instance, in the example machine 100, a coating mechanism 126 is implemented as a spreader that rakes powder from the powder storage bed 118 and spreads the powder in a fine layer over the top surface 124 of the powder bed 112 of the workpiece platform 102. The spreader of the coating mechanism 126 may comprise a blade that spreads a thin layer of powder over the powder bed 112. Alternatively, the spreader can be implemented as another suitable structure, e.g., roller, etc.

More particularly, the powder in the powder storage bed 118 defined by the cavity of the supply platter will start level with the powder coating mechanism 126. The build platter will then move down a finite amount according to the desired layer dimensions, e.g., by controlling the first motor 116 to lower the support plate 114, thus creating the powder bed 112 via a cavity of the workpiece platform 102. An example may be approximately 20 or more microns (e.g., >˜20 microns). The supply platter raises a defined amount, e.g., by controlling the second motor to raise the supply plate 120, which pushes some powder above a spreading level. A spreader of the coating mechanism 126 takes this powder, collecting it as it traverses across the supply platter area, and deposits the powder above the build platter (i.e., across to a top surface 124 of a powder bed 112), filling the build cavity. The excess powder remaining after filling the build cavity is swept off the end into a powder catch 130 and can be reclaimed and reused if desired. This process repeats to build the part, layer-by-layer.

Scraping Mechanism

In an example configuration, the coating mechanism 126 is driven by a carriage style linear actuator. On the opposite side of the linear actuator is an unpowered rail and carriage. A cross beam connects the actuator to the carriage, spanning the width of the platters. Mounted onto the top of this horizontal cross beam is a 90-degree bracket, allowing a vertical scraper to hang off the edge. Bolts attaching the spreading plate to the 90-degree bracket allow the spreading plane to be adjusted. Moreover, a conformal rubber gasket forms the scraper to prevent failed builds.

Often, multiple parts are created simultaneously using different parameters for optimization. However, less than optimal parameters can cause the solidified powder to warp above the level of the spread powder. In conventional machines, the scraper would collide with these warped elements and cause the entire build to fail. If this were to occur, a technician or engineer would be required to halt the build, open the machine, file or hammer the specific raised geometry, then restart the build without further processing of the failed geometry.

Stopping and starting allows the part to cool, introduces oxygen into the part, and creates potential discrepancies in other surrounding builds. However, the use of a conformal blade allows the blade to flex when encountering a rigid warped surface, which prevents catastrophic collisions and allows the build to continue to completion. In practical applications however, the machine 100 allows both a rotating roller to be used as the spreading mechanism, instead of the conformal scraper, if the material or process would require.

Part Measurement

Moreover, the controller 108 selectively utilizes the measurement device 110 (where provided and/or utilized) to measure the part 128 as it is being created. By detecting the profile of the actual part 128, e.g., via scanning, image analysis, etc., the actual part can be compared to a model expressed as a three-dimensional representation of the part. Based upon the detected differences, a correction file is generated. The correction file is used to control a material manipulation process (e.g., in the form of subtractive manufacturing, micro-machining, material manipulation, a combination thereof, etc.).

For instance, the material manipulation process can be implemented as a subtractive manufacturing or otherwise micro-machining process to remove material from the part 128 until the part matches the three-dimensional representation of the part to a desired tolerance. The correction may also and/or alternatively include re-melting or repeating any part of an additive process. Yet further, the correction may be a material property modification, e.g., to alter grain direction, brittleness, stress/strain behavior, elastic properties, ductility, shear properties, etc., as set out in greater detail herein. Notably, such corrections are performed in-process, thus catching and correcting errors as they occur and/or manipulating materials properties as the part is being built. This allows for significantly greater precision compared to performing subtractive processing on a finished part.

As an illustrative example, the measurement device 110 can be implemented as a three-dimensional surface profilometer, such as a laser-based profilometer. In alternative configurations, the measurement from the measurement device 110 can alternatively comprise a high-speed camera rendering e.g., from a suitable high speed camera, an in-line confocal microscopy output from a microscope, or other technology that allows the detection in differences between the actual part being built and the corresponding three-dimensional representation.

The technology utilized to implement the measurement device 110 can dictate how the measurement device 110 is integrated into the machine 100. For instance, where the measurement device 110 is a camera, the camera can be integrated into the scan head 106. In this regard, the camera may share one or more optical elements with the energy sources, or the camera can have its own independent optical pathway, including lenses, mirrors, filters, etc.

On the other hand, for where the measurement device 110 is implemented as a scanning device, such as a linear laser profilometer, in-line scanning microscope, etc., the measurement device, the measurement device 110 can include a linear translation stage. Alternatively, the measurement device 110 can be mounted on the spreader of the coating mechanism 126 since that device already traverses the powder bed 112. For instance, the measurement device 110 can comprise a profilometer (e.g., a laser profilometer) attached to the spreader of the powder delivery system.

Regardless of the underlying technology, the measurement device 110 generates an output, e.g., an image, a scan, signal, etc., that is communicated back to the controller 108. This communication can include other relevant data, such as position information, a time stamp, or other data needed by the controller 108. The controller 108 uses the result to determine whether a correction is required. As such, an output of the measurement device 110 is used as part of a feedback loop to improve part consistency.

As an illustrative example, the controller 108 can process the three-dimensional representation of the part as a CAD (computer aided design) file. The three-dimensional representation is split up into two-dimensional slices, where each slice corresponds to a layer of manufacturing. Once a given layer is built through additive manufacturing, the measurement device 110 inspects the layer just built. The results are converted into a format that can be compared to the two-dimensional slice just built. If the results from the inspection, e.g., the profile of the measured part, differs from the corresponding two-slice data, the differences can be built into a machining layer that can direct the laser micro-machining operation.

As another example, the controller 108 can classify the discrepancies. As an example of classification, if the controller 108 detects a discrepancy in the X-Y profile, the controller 108 may build a machine file to initiate a micro-machining operation. If the controller 108 detects a discrepancy in the Z direction, e.g., due to a surface aberration (Z), the controller 108 can build a control file to cause selective re-melting. Notably, an inspection operation may result in no correction, one or more material manipulation operations (e.g., a laser micro-machining operation, a re-melting, or other operation as set out in greater detail herein) or combination thereof. Moreover, after a corrective action, the controller 108 may trigger a re-inspection. Alternatively, the controller 108 can move on to the next build layer.

The comparison can use a threshold, percentage deviation, or other suitable measure, depending for instance, upon the desired tolerances. In alternative configurations, the controller 108 can implement an open loop configuration.

Operation

In operation, a powder layer is distributed across the powder bed 112 of the workpiece platform 102. Once the powder layer is distributed, the scan head 106 emits a first energy beam under control of the controller 108 that binds together, e.g., via melting, select portions of the powder layer according to an associated two-dimensional slice of the three-dimensional representation of a part 128 to be constructed. The scan head 106 can also optionally emits a second energy beam that performs selective material manipulation (e.g., which can include subtractive manufacturing, micro-machining, re-melting, ablation, material property modification, material surface modification, material position modification, a combination thereof, etc.). The above process is repeated layer by layer (two-dimensional slice by two-dimensional slice) until the build is complete. As such, for each layer, there may be a powder distribution process, an additive process, a material manipulation process, a corrective additive process, or any combination thereof.

In an example configuration, as each successive layer of the part 128 is built up, the controller 108 controls the first motor 116 to lower the support plate 114 of the workpiece platform 102 (as schematically illustrated by the downward directional arrow). Similarly, as each successive layer of the part 128 is built up, the controller 108 controls the second motor 122 to raise the delivery plate 120, thus raising the powder storage bed 118. Raising the powder storage bed 118 raises the powder held by the powder delivery system 104, thus allowing the coating mechanism 126 to spread a new layer of powder over the powder bed 112 of the workpiece platform 102. The optional a powder catch 130 can be provided to reclaim and recycle powder that is not used to form the part 128.

Notably, in the example configuration of FIG. 1, the build platter may traverse in a Z-dimension (seen vertically on the page), whereas the energy beams are scanned in an X-dimension and a Y-dimension (each orthogonal to the Z-dimension and orthogonal to each other) according to each two-dimensional slice of the corresponding control file.

Powder Fed Example Configuration

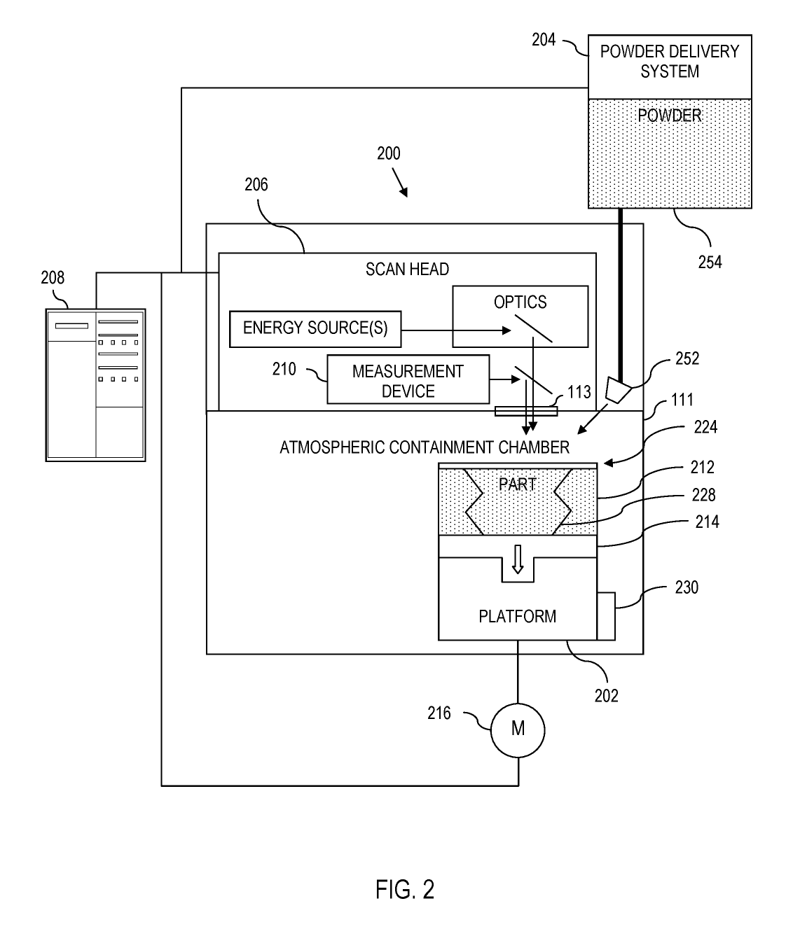

Referring to FIG. 2, a hybrid laser micro-manufacturing machine 200 is illustrated according to further aspects of the present disclosure. Many of the components of the hybrid laser micro-manufacturing machine 200 are identical to those of the hybrid laser micro-manufacturing machine 100. As such, like components are illustrated with a reference numeral 100 digits higher than the corresponding components of FIG. 1.

The hybrid laser micro-manufacturing machine 200 comprises in general, a workpiece platform 202, a powder delivery system 204, a scan head 206, and a controller 208 analogous to that of FIG. 1. The hybrid laser micro-manufacturing machine 200 can also include an optional measurement device 210, also analogous to FIG. 1.

The hybrid laser micro-manufacturing machine 200 differs from the hybrid laser micro-manufacturing machine 100 of FIG. 1, in that the powder delivery system 204 is implemented as a powder feed system. In this configuration, the powder is fed towards the build platter by a nozzle 252 situated above the workpiece platform 202. In this configuration, the powder delivery system 204 delivers powder from a powder reservoir 254 to the workpiece by ejecting powder through the nozzle to expel the ejected powder towards the workpiece platform, as the energy beam is directed towards the build platter.

In example configurations, the energy beam is in a fixed orientation. The motor 216 (or combination of motors) controls the build platter to traverse in the X-dimension, Y-dimension, and Z-dimension. Otherwise, the functionality of integrating additive and material manipulation manufacturing is the same as set out in greater detail herein.

The Scan Head

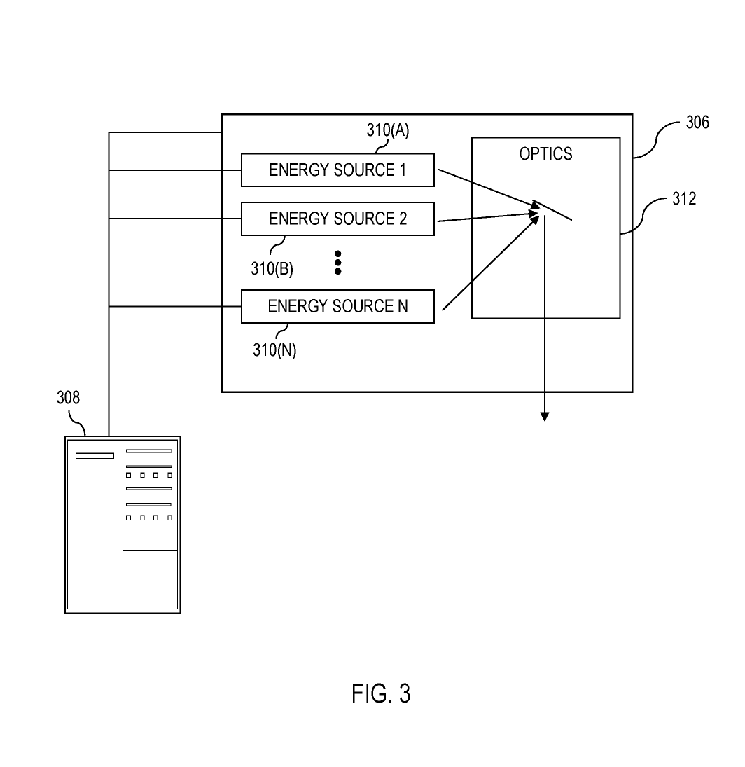

Referring to FIG. 3, a scan head 306 and corresponding controller 308 are illustrated. The scan head 306 is analogous in function to the scan head 106 of FIG. 1 and scan head 206 of FIG. 2, and can thus be utilized with the embodiment of FIG. 1, the embodiment of FIG. 2, or both. Likewise, the controller 308 is analogous in function to the controller 108 of FIG. 1 and controller 208 of FIG. 2, and can thus be utilized with the embodiment of FIG. 1, the embodiment of FIG. 2, or both.

The scan head 306 includes one or more energy sources 310, e.g., lasers, as well as optics 312 necessary to direct the energy beams towards the top surface 124 of the workpiece platform 102. In this manner, the scan head 306 can utilize one or more energy sources 310 for additive processing, one or more energy sources 310 for material manipulation processing, and one or more optional energy sources 310 for part measurements. For instance, a first energy source 310(A) can be selected for additive processing, a second energy source 310(B) can be used for material manipulation processing, and a third energy source 310(C) can be used for profile measurements. Here, each laser source 310 can have different or similar characteristics. For instance, when implemented as lasers, each laser source can be manipulated to achieve the same or different wavelength, power, beam diameter, pulse duration, etc.

The optics can include a mirror, e.g., a rotating polygonal mirror, scanning galvanometer mirror, or other suitable mirror structure for scanning, one or more lenses, dichroic mirror, other optical structures, a combination of the above, etc., as necessary to focus beams onto the part. Moreover, the scan head 306 may include laser control electronics, e.g., to vary the power or other controllable energy source parameters.

The controller 308 controls the scan head 306 to emit a first energy beam that implements an additive process on the part (e.g., part 128 of FIG. 1). In this manner, the controller 308 implements computer controlled laser path selection to select and control the scan head 306 to emit the first energy beam according to the program executed by the controller 308 to selectively melt powder proximate to the top surface of the workpiece platform to add structure to the part (e.g., top surface 124 of the workpiece platform 102 to add structure to the part 128).

The controller 308 also controls the scan head 306 to emit a second energy beam that implements a material manipulation (e.g., which can include subtractive manufacturing, micro-machining, re-melting, ablation, material property modification, material surface modification, material position modification, a combination thereof, etc.) of the part. In this manner, the controller 308 implements computer controlled laser path selection to select and control the scan head 306 to emit the second energy beam to perform the desired material manipulation operation. For instance, instructions to selectively remove material from the part 128 can be based upon an output from the measurement device 310, material property modifications can be specified in the control file, etc.

In certain embodiments, at least one energy source 310 can comprise a femtosecond laser. This allows material manipulation operations such as plane operations to achieve desired smoothness. The controller 308 can also control the femtosecond laser to create structures on a surface, e.g., waffle structures, channels, undulating surfaces, etc., down to the nanometer layer dimensions. Such may be desirable to roughen a surface for bonding with a new/different material. In other embodiments, a picosecond laser may be utilized.

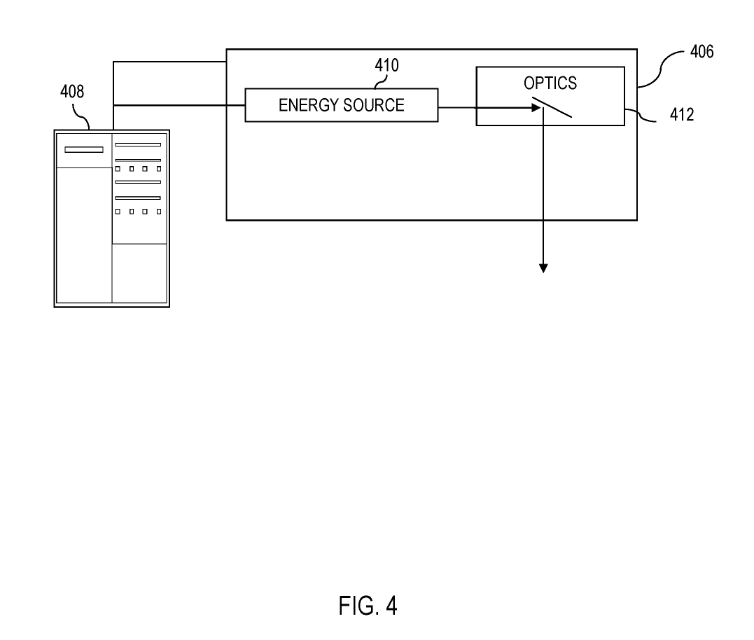

Referring to FIG. 4, a scan head 406 is illustrated. The scan head 406 is analogous in function to the scan head 106 and scan head 206, and can thus be utilized with the embodiment of FIG. 1, the embodiment of FIG. 2, or both. In the illustrated alternative configuration, the scan head 406 is identical to the scan head 306 except that the multiple energy sources are replaced with a single energy source 410. Likewise, the controller 408 is analogous in function to the controller 108 of FIG. 1 and controller 208 of FIG. 2, and can thus be utilized with the embodiment of FIG. 1, the embodiment of FIG. 2, or both.

Here, the controller 408 may optionally vary the power or other modifiable parameters of the energy source 410, e.g., a laser to implement additive, material manipulation, and optionally measurement duties. The scan head 406 can also optionally include one or more energy sources, cameras, etc., for part measurements, i.e., operations other than additive and/or material manipulations.

In examples herein, the scan head 106, scan head 206, scan head 306 and scan head 406 utilize one or more lasers. However, any other suitable energy source may be utilized. For instance, one or more of the lasers can be replaced with an electron beam discharge device or other suitable structure.

In an example configuration, the scan head comprises an energy source, e.g., at least one laser, and corresponding optics, e.g., a dichroic mirror, a galvanic mirror system, etc. As noted in greater detail herein, a measurement device can be integrated into the scan head or the measurement device can be external to the scan head, depending upon the desired implementation. Regardless, in this example embodiment, the scan head and the measurement device work in conjunction with the controller to document the work, e.g., document the build, repair, process of operations, etc. Moreover, in this example embodiment, the measurement device, scan head, and controller cooperate to confirm the geometry of the part being worked on.

In an example embodiment, the controller is programmed to calibrate two lasers, e.g., laser 1 and laser 2 to one line. For instance, the controller can align laser 1 using cross-hairs, the controller turns on laser 2 and calculates an offset between laser 2 and the cross hairs (and thus laser 1). This offset is stored for use when engaging laser 2 to make a scan.

Also, a beam expander can be used to adjust the beam size of one or more of the laser beams. For instance, a beam expander can be used to ensure that the beam diameter of laser 2 is the same size or smaller than the beam diameter of laser 1. Thus, laser 1 can be used for additive manufacturing, and laser 2 can be used for material manipulation. In other embodiments, the beam size of laser 2 can be made the same size or larger. In the case of a single laser source, a galvanic mirror system can be used to move the beam expander into and out of the optical path such that when the laser is functioning in an additive mode, the beam diameter is different from when the beam is functioning in a material manipulation mode, e.g., micro-machining mode.

Example Implementation

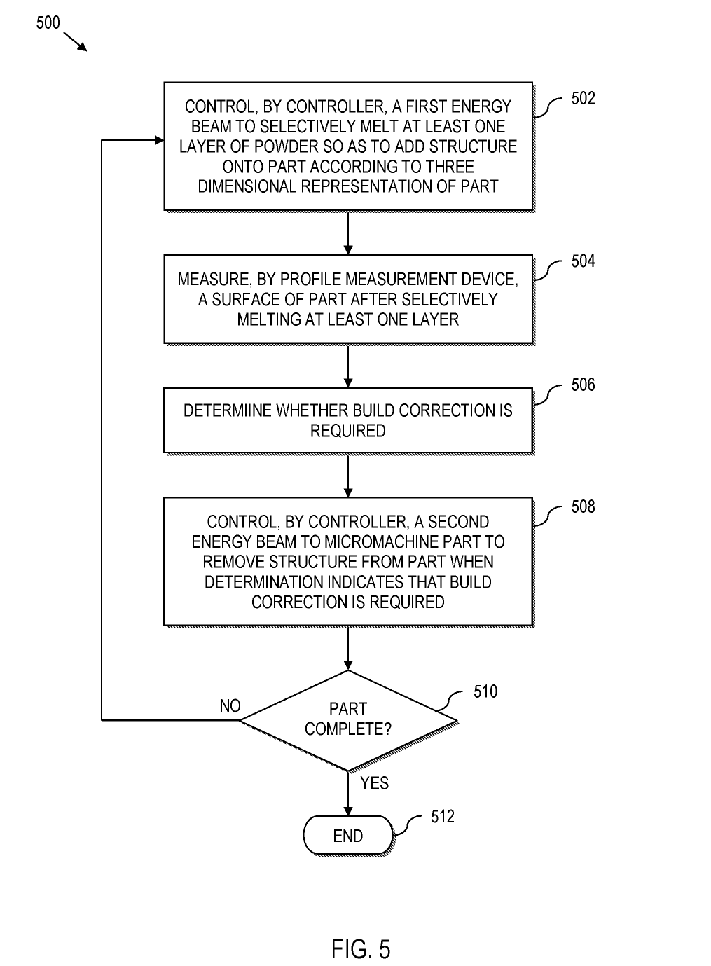

An example process of implementing hybrid laser micro-manufacturing is described with reference to FIG. 5. The illustrated process can be implemented on the hybrid laser micro-manufacturing machine 100 of FIG. 1, the hybrid laser micro-manufacturing machine 200 of FIG. 2, or both. Moreover, the process can optionally utilize the scan head 306 of FIG. 3 or scan head 406 of FIG. 4. Also, the process of FIG. 5 can be implemented on other machines that are configured to be suitable for carrying out the described process.

A process 500 of implementing hybrid manufacturing in a single machine is illustrated. The process 500 comprises repeatedly performing a sequence of machining operations.

In particular, the process comprises controlling, at 502, by a controller, a first energy beam to selectively melt at least one layer of powder to add structure onto a part according to a three-dimensional representation of the part.

In certain implementations, the process 500 can include an optional process of measuring, at 504, by a measurement device, a surface of the part after selectively melting the at least one layer.

Regardless of whether a scan is performed, the process 500 also comprises determining, at 506, whether a build correction is required.

For instance, the process 500 comprises controlling, at 508, by the controller, a second energy beam to micro-machine the part to remove structure from the part when the determination indicates that a build correction is required that is indicative of a deviation from a predetermined tolerance, and that the correction requires removing portions of the part. The process 500 can also comprise controlling, at 508, by the controller, the second energy beam to perform other material manipulations as set out in greater detail herein.

A decision is then made at 510 to determine whether the part is complete. If the part is complete, the process stops. Otherwise, the process 500 loops back to 502 and the loop repeats.

As noted above, in example configurations, the process can comprise measuring at 504, by a measurement device, a surface of the part after selectively melting at least one layer. For instance, a measurement device can be used for producing a surface map based upon the scan of the surface of the part. Under this configuration, the process of determining at 506, whether a build correction is required may be implemented based upon the results of the measurements by the measurement device, such as by generating a difference file between the surface map and the corresponding two-dimensional slice of the three-dimensional representation of the part.

In further example configurations, controlling, at 508, by the controller, a second energy beam to perform material manipulation of the part (e.g., to remove structure from the part, to modify a material property, to position material, etc.) when the determination indicates that a build correction is required, comprises micro-machining only targeted defects that are detected as a result of comparing the measurement by the profile measurement device to the corresponding layer in the three-dimensional representation. In this regard, depending upon the measurement device, appropriate transforms, mapping, scaling, and other processing may be required. For instance, a laser scanning profilometer will have a different output format compared to a camera, etc. As such, the controller may require image processing and conversion capabilities, which are dependent upon the type of measurement device.

Moreover, in certain applications, e.g., where high precision is required, the first energy beam can be controlled at 502, to selectively melt a single layer before measuring at 504 by the measurement device. That is, a measurement is taken every layer of buildup. In alternative configurations, the first energy beam can be controlled at 502, to selectively melt multiple layers before measuring at 504, by the profile measurement device. This alternative configuration provides for faster build time by not measuring every layer of buildup. In this regard, the interval of layers between successive scans can be set via programming. For instance, it may be desirable to scan every 5-10 layers, or some other predetermined interval. Moreover, a scan can be triggered dynamically, e.g., based upon one or more factors. For instance, when a two-dimensional profile changes beyond some predetermined threshold, the scan at 504 may be triggered. Yet further examples, when one or more process parameters change beyond a predetermined threshold, e.g., laser power, powder material, two-dimensional profile, temperature, or other measurable process parameters, a measuring operation at 504 can be triggered.

The process of controlling, at 508, by the controller, a second energy beam to micro-machine the part can comprise performing the micro-machining operation to create a feature size that is finer than what is otherwise possible with the first energy beam alone. Micromachining can also be used to correct surface and/or sub-surface defects (e.g., correct surface features, remove voids, etc.)

In illustrative example implementations, a build correction is determined to be required by comparing a result of measuring by the measurement device to a corresponding layer in the three-dimensional representation of the part, and determining a that a build correction is required by detecting that the result of the measuring by the measurement device differs from the three-dimensional representation by a predetermined threshold. In alternative example implementations, a build correction is determined to be required by detecting that a predetermined number of layers have been added by the first energy beam. As another example, a build correction can be coded into the control file, e.g., to alter grain direction, a stress property, hardness, brittleness, a compressive characteristic, a sheer characteristic, an elastic property, ductility, etc.

The process 500 may optionally further comprise utilizing a powder delivery system to deliver powder from a powder storage system to a powder bed having a workpiece platform, and utilizing a coating mechanism having a spreader to spread a powder layer delivered to the powder bed by the powder delivery system to define a build plane, e.g., using the structure of FIG. 1. In this example configuration, controlling, by a controller, a first energy beam to selectively melt at least one layer of powder comprises controlling the first beam to melt the powder in the build plane according to a cross-section of the part based upon data from the three-dimensional representation of the part. Alternatively, powder can be delivered to the powder bed via a powder fed system, such as that described with reference to FIG. 2.

As noted above, in an example implementation, a determination as to whether a build correction is required can be made by comparing a surface map rendered as a result of measuring the part with a measurement device to a corresponding layer in the three-dimensional representation of the part. In this example, the controller controls the second energy beam to micro-machine the part to remove structure from the part when the determination indicates that a build correction is required, by guiding the micro-machining operation based upon a difference between the corresponding layer in the three-dimensional representation of the part and the surface map.

For instance, to judge whether a build correction is required, the controller can compare the output of the measurement device to a corresponding layer in the three-dimensional representation of the part, to identify one or more predetermined deviations. A predetermined deviation can be defined, for instance, as a defect or geometric inaccuracy in a measured layer. Another example predetermined deviation is an identified edge or surface roughness in the measured layer that deviates by a predetermined tolerance from the corresponding layer in the three-dimensional representation. Under the above-conditions, the controller controls the scan head to emit the second energy beam to micro-machine the part to remove structure from the part to cut away any defects, excess surface roughness, or geometric inaccuracies in the scanned layer.

As a further example, determining whether a build correction is required can comprise identifying areas in the scanned layer (hence the last built layer) that require re-melting. In response to determining that an area requires re-melting, the process further comprises controlling, by a controller, the first energy beam to selectively re-melt the scanned layer based upon the identified areas in the scanned layer that require re-melting.

In example configurations, the first energy beam and the second energy beam are emitted from the same laser source. In this regard, the process may optionally further comprise controlling, by the controller, at least one parameter of the laser source such that the first energy beam has at least one different property compared to the second energy beam.

According to yet further aspects of the present disclosure, combinations of additive and laser material manipulation can be utilized to create intentional surface roughness features. For example, there may be situations where surface roughness is required to join two different materials together, e.g., a polymer to a metal. By creating intentional surface roughness, features, or other surface conditions, more stable and reliable bonding can be achieved.

Yet further, the combination of additive processing and material manipulation as described more fully herein can be used to grade out the part. For instance, the part can be graded out from nickel and titanium to pure nickel at the edges so that the part can bond to another material, e.g., stainless steel.

In yet another embodiment, the controller controls a process whereby a powder layer is melted (e.g., an X-Y layer) by scanning a first laser beam (e.g., additive beam) to perform an additive process. A second beam (material manipulation beam), e.g., having at least one different characteristic or process parameter compared to the first laser beam, follows the scan of the first laser beam to perform a material manipulation operation.

The second beam can be an electron beam, laser beam, etc. The different process parameter(s) can include beam diameter, energy, wavelength, scan location, or other parameters as the application dictates. For instance, the system can run open loop or closed loop. Thus, for instance, the controller can be operatively programmed to always perform micro-machining on one or more corners or other features of a part being worked on. Again, the additive beam and material manipulation beam can be derived from the same energy source, or a first energy source, e.g., first laser can be designated an additive laser and a second energy source, e.g., a second laser, can be designated as a material manipulation laser.

Notably, this ability to controllably material manipulations including micro-machining, in turn with an additive process (e.g., selectively micro-machine layer-by-layer) enables the system to control residual stress while building, modifying, or repairing a part.

Moreover, build characteristics can be achieved that are not otherwise possible with conventional systems. For instance, the system can be configured to use a first laser beam to build an X μm layer (e.g., 25 μm) layer, then perform a micro-machining operation that machines off X-Y μm (X>Y), (e.g., 5 μm) across the entire layer that was just built, leaving a 20 μm layer. This can remove the residual stress of the overall part. As noted in greater detail herein, micro-machining need not occur on every layer (although it can). Moreover, micro-machining need not occur across the entire scan pattern used to build a layer.

Further, material properties can be more readily controlled, and controlled to a significantly finer level of detail by selectively micro-machining using one or more of the techniques as set out herein. For instance, disrupting the additive process can result in more random grain structure. The ability to control grain structure may be critical, such as in applications that require a process to qualify material properties.

Thus, the techniques herein are not limited to improving visual/finish details. Rather, microstructure/grain size, hardness, and other properties can be controlled and manipulated. By way of example, a part may need to satisfy a certain measure of tensile strength requirement in one region, but a specific compressive requirement in another region. This would be difficult if not impossible with conventional additive systems. However, as set out herein, material manipulation including micro-machining is used to manipulate the material properties, even down to the grain level, allowing the creation and repair of parts having complex metallurgy requirements. For instance, the controller herein can manipulate the metallurgy to change the material properties of a part as it grows during a manufacturing operation, by selectively controlling how and when micro-machining is performed.

Example Material Manipulations

As noted more fully herein, material manipulation can include subtractive manufacturing, micro-machining, re-melting, ablation, material property modification, material surface modification, material position modification, a combination thereof, etc. In this regard, a few illustrative examples are discussed below. In this regard, the controller controls the laser pulse intensity of the manipulation laser beam to be above the ablation threshold (e.g., to remove material) or below the ablation threshold (e.g., to change material property by imparting stress or removing stress). Moreover, the material manipulation beam can be used to induce mechanical effects, thermal effects, or both.

Powder Bed Manipulation

In an example configuration, an energy source, e.g., a laser source designated as a material manipulation laser, can be used to manipulate the powder bed. For instance, using pressure differential, the material manipulation laser can move powder without melting the powder. Such may be used to position material for additive processes, or for other purposes, e.g., to position material for re-melting, surface modifications, etc. In this regard, process parameters, e.g., beam diameter, power, etc., may be manipulated by the controller for powder bed manipulation operations.

Laser Peening

As another example, the energy source (e.g., material manipulation laser) designated for material manipulation operations can be used to perform surface engineering processes, e.g., to impart beneficial residual stresses, and/or relieve non-beneficial stresses (including residual stresses) in materials. For instance, as the melt cools, the material can form stresses. Depending upon the material selected, and geometry of the feature being formed, this can create structural issues with the part. However, a portion of the melted layer can be manipulated in a laser peening operation, thus reducing or eliminating the stresses that would otherwise remain in the part. The laser peening process can also include micro-machining to remove materials to alter stress properties.

Material Property Modification

Still further, by scanning a layer or portion thereof, the material property can be manipulated with or without removing material. For instance, compressive force characteristics can be manipulated, etc. In practice, other mechanical surface enhancement processes and/or thermal processes can also and/or alternatively be performed. By way of example, an energy source used to perform a material manipulation can be configured and controlled by the controller to emit high energy pulsed laser beam that propagates shock waves through the part producing controlled residual stresses, e.g., to increase the resistance of the material of the part to fatigue, stress corrosion cracking, etc. Additionally, properties such as stress, hardness, brittleness, a compressive characteristic, a sheer characteristic, an elastic property, ductility, etc., can be controlled by adjusting laser operating parameters, beam size, beam location, beam energy, etc.

Regardless of embodiment, the controller can utilize pre-programmed instructions to perform material property modification and/or micro-machining. Alternatively, the measurement device can provide feedback to the controller to dynamically determine when to manipulate the part, powder bed, or other aspect of the process. Still further, a combination of pre-programmed instructions and dynamic measurements can be utilized to build a part.

Re-Melting

In certain operations, it may be beneficial to re-melt the material or a portion thereof, without machining away material. In this regard, the controller can selectively re-melt one or more portions of a layer, e.g., based upon pre-programmed instructions, based upon feedback from the measurement device, or a combination thereof.

No Re-Melting

In other embodiments, re-melting is avoided. However, stress removal can be performed without damage to the layer. For instance, by setting laser power above an ablation level, stress is removed without further damage to the part/layer.

Surface Preparation

According to still further aspects of the present disclosure, a laser scan can be used to cut, modify, prepare, or otherwise treat a surface for subsequent processing. By way of example, an undulating pattern can be cut or otherwise etched into the surface of a part, such as to form channels or islands. This can be performed to allow another material to better bond with the current layer. Alternatively, the pattern can be used to create or remove stresses, reduce geometry distortion, provide better wear fatigue, etc. Moreover, custom material property profiles can be derived, e.g., by creating stress in certain areas, while removing stress in other areas of a surface/layer. As for additional examples, the material modification laser can remove all or part of a layer in a customized pattern. Moreover, material can be manipulated, e.g., to derive a customized stress profile.

Defect Removal

During the additive process, defects can arise in the surface roughness and in the formation of undesired voids, pour or other defects. Here, the material modification laser can be used to perform laser micro-machining, e.g., to remove a part/powder interface, skin, and/or adjacent layer(s). Here, subtractive laser micro-machining can be carried out on an edge of the part, or slightly inward from an edge (e.g., to remove material defects such as voids, pours, etc. Defect removal can be practiced along with surface property manipulation.

Stress Enabling/Enhancing

Moreover, it may be desirable in certain applications to leave and/or enhance some or all detected stress in a layer being manufactured. For instance, in a region where stress is not a critical parameter, it can be ignored. In alternative configurations, stresses can be precisely controlled to meet product specifications.

Beam Following

In certain embodiments, a second beam simultaneously manipulates as a first beam performs an additive operation. Here, the second beam may follow the first beam, e.g., by a gap of a predetermined distance, amount of time, or other design parameter.

Observations

The machine 100 (FIG. 1) or 200 (FIG. 2), scan head 306 (FIG. 3), scan head 406 (FIG. 4), process 500 (FIG. 5) can be used for new part generation, to repair parts, to modify existing parts, or for other applications. For instance, the controller 108 (FIG. 1) can execute a program to build the part 128 (FIG. 1) as a new part layer-by-layer. As another example, the controller 108 (FIG. 1) can execute a program to modify or repair an existing part 128 (FIG. 1), etc.

Accordingly, aspects of the present disclosure provide a system capable of performing laser-based material manipulation in an additive manufacturing process. Furthermore, the machine is capable of performing measurements of the part on every single layer of the three-dimensional manufacturing process. Moreover, the machine is capable of performing material manipulation processing on every single layer of the three-dimensional manufacturing process. Laser micro-machining processes on every layer (or as required by the build) enables the machine to create much finer feature sizes that are possible without the subtractive processing. Moreover, material manipulation can be performed after the additive process is entirely complete. Yet further, material manipulation processing can be performed every layer, after several layers of additive manufacturing, whenever a profile measurement deviates from a predetermined range, etc.

For instance, in example implementations of the present disclosure, the laser micro-machining process is guided by the output of the measurement device (e.g., three-dimensional surface profilometry, image data, etc.). In this regard, as noted more fully herein, such measurement output can be collected on every layer (or other desired or otherwise triggered interval) of a part, as it is built. The measurement data (e.g., surface profilometry data) allows material manipulation laser machining to be targeted towards specific defects or machining operations.

In an example implementation, a hybrid additive and material manipulation laser micro-manufacturing process, also referred to as selective laser ablation and melting (SLAM) in certain iterations, combines a selective laser melting (SLM) additive manufacturing process with material manipulation. Moreover, certain implementations additionally include the use of part monitoring, e.g., through profile inspection using a three-dimensional surface profilometry processes, camera imaging, microscopy, etc., to guide corrections to deviations in the actual part build up.

As noted more fully herein, in an example, e.g., using the machine 100 of FIG. 1, in a first part of a process, a thin layer of metal powder (non-metal powder could also be used) is spread onto a build plane and then a cross-section of a three-dimensional part is melted with a high-power laser. Next, a surface profilometer scans the recently melted layer, thus producing a surface map that is used to guide a micro-machining process. More particularly, the profilometer data is used to inform the controller of any defects or geometric inaccuracies in the layer. The controller also uses the profilometer data to determine edge and surface roughness. The material modification beam is then used to cut away any defects, excess surface roughness, or geometric inaccuracies. The material manipulation process thus ensures that every layer of the part is consistent and built very accurately.

Also, as noted in greater detail herein, in certain implementations, the measurement data identifies areas that require re-melting with the additive laser, so these operations can also be performed immediately before, during, or after material manipulation machining operations.

The lasers for additive and material manipulation processes could be either multiple lasers or the same laser. In some applications, it may be desirable to have significantly different lasers for the additive and material manipulation processes. Nevertheless, modern laser technology makes it feasible to use the same laser for both processes, where the laser settings are simply varied between additive and material manipulation steps.

In certain applications, processing may be performed without a corresponding measurement process guiding the material manipulation operations. For instance, the process can be informed of material manipulations via the control file, or the system can perform material manipulation operations on every layer (or on specific layers based upon some trigger, e.g., every n layers, based upon the geometry of the part, etc.) that simply sharpen the overall layer geometry without targeting specific features.

Existing traditional manufacturing techniques lack customization capabilities that are possible with hybrid manufacturing processes set out herein. Moreover, current manufacturing techniques are not adequate for micro-manufacturing. For instance, a minimum feature size of current processes is dictated by the melt pool size, which is in turn dictated by several factors (including layer thickness and laser spot size). However, the processes described more fully herein, are not constrained by the melt pool size. For instance, the laser-based material manipulation processing herein enables smaller (e.g., <10 um (micrometers)) feature sizes under a wide range of build conditions. This allows for micro-additive manufacturing of devices that is faster and more accurate than currently possible.

The processes described herein also enable the creation of parts with relatively greater density consistency and mechanical properties compared to traditional machines. The improved characteristics may be facilitated through part measurements, which enable the processes herein to measure exact powder condensing to enable adaptive layer thickness control, so every layer of a part is exactly the correct thickness. This facilitates consistent layer density, which facilitates consistent mechanical properties. Detection and repair of specific defects also aides the consistency and success of the micro-manufacturing process.

Current solutions are not capable of the type and resolution of feature size control, layer thickness control, defect removal, and material property manipulation as described herein. For instance, there are several issues with waiting to perform subtractive machining after the additive process has finished, e.g., using traditional CNC milling with this technique. For example, it may be impossible to machine internal features after a part has been constructed. However, because the processes of the present disclosure are capable of micro-machine material manipulation processing, the present system can machine internal features. Also, traditional CNC milling is not as precise as laser micro-machining. Yet further, traditional CNC processes do not have the part measurement (e.g., profilometry-based) layer thickness and defect control of the machine herein. Yet further, material properties such as a stress property, hardness, brittleness, a compressive characteristic, a sheer characteristic, an elastic property, and ductility can be controlled layer by layer, and even within a targeted region of a layer.

The measurement device 110 of the machine 100 (FIG. 1), measurement device 210 of the machine 200 (FIG. 2) enable processing that achieves small feature sizes, while providing layer thickness and defect control.

Certain existing micro-additive manufacturing solutions work by using very small (<5 um) powder particles and equally small layer thicknesses. This, combined with a small (<50 um) laser spot size allows small features to be fabricated. There are several drawbacks to this approach. For example, such smaller layer thicknesses make it impractical to build parts longer than a few millimeters (mm) in length. Another example of a drawback of existing micro-additive manufacturing solutions includes final feature size and surface finish. For example, melt pools in conventional systems are textured by surrounding powder, and therefore will still have some excess surface roughness, and the melt pool size is going to make the minimum feature size larger than that which can be achieved with material manipulation micro-machining lasers described herein.

The part measurement and in-process build inspection, combined with material manipulation processing described herein improves the consistency of materials in every part and will also make micro-additive manufacturing far more feasible. This is pertinent for example, in medical-device manufacturing, where micro-features are often needed on components that are too long to make in a timely fashion on current micro-additive systems. For example, a neuro electrode in which micro-features are present may be approximately 25 mm in length. The approaches herein allow relatively thicker layers to be manufactured (over current solutions), which will greatly decrease build time, which achieving similar or superior results by micro-machining to the desired tolerances. More consistent material properties are also important, and required for any additively fabricated components to be used in critical systems in either the biomedical or aerospace industries.

The machines and processes described herein perform material manipulation, laser-micro-machining, part measurement/inspection, or a combination thereof during the additive manufacturing process—potentially on every layer of a part during the building process. Further, machines and processes described herein may use in situ surface profilometry to guide the material manipulation machining process, to control layer thickness, and to identify and repair defects on every layer.

Computer System Overview

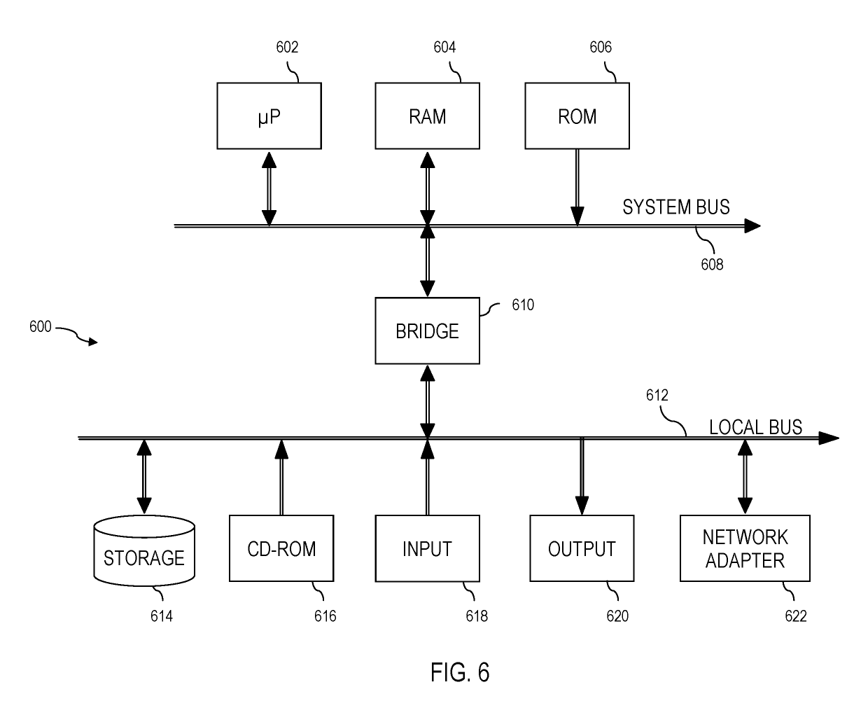

Referring to FIG. 6, a schematic block diagram illustrates an exemplary computer system 600 for implementing the controller 108, 208, 308, 408 that carries out the various processes described herein. The exemplary computer system 600 includes one or more (hardware) microprocessors (μP) 602 and corresponding (hardware) memory (e.g., random access memory 604 and/or read only memory 606) that are connected to a system bus 608. Information can be passed between the system bus 608 and local bus 612 by a suitable bridge 610 to communicate with various input/output devices. For instance, a local bus 612 is used to interface peripherals with the one or more microprocessors (μP) 602. In the regard, peripherals may include storage 614 (e.g., hard disk drives); removable media storage devices 616 (e.g., flash drives, DVD-ROM drives, CD-ROM drives, floppy drives, etc.); I/O devices such as input device 618 (e.g., mouse, keyboard, scanner, etc.) output devices 620 (e.g., monitor, printer, etc.); and a network adapter 622. The above list of peripherals is presented by way of illustration, and is not intended to be limiting. Other peripheral devices may be suitably integrated into the computer system 600.

The microprocessor(s) 602 control operation of the exemplary computer system 600. Moreover, one or more of the microprocessor(s) 602 execute computer readable code (e.g., stored in the memory 604, 606 storage 614, removable media insertable into the removable media storage 616 or combinations thereof) that instructs the microprocessor(s) 602 to implement the processes herein.

The methods and processes herein may be implemented as a machine-executable process executed on a computer system, e.g., the controller 108 of FIG. 1, the controller 208 of FIG. 2, etc.

Computer program code for carrying out operations for aspects of the present disclosure may be written in any combination of one or more programming languages. The program code may execute entirely on the computer system 600 or partly on the computer system 600. In the latter scenario, the remote computer may be connected to the computer system 600 through any type of network connection, e.g., using the network adapter 622 of the computer system 600.

In implementing computer aspects of the present disclosure, any combination of computer-readable medium may be utilized. The computer-readable medium may be a computer readable signal medium, a computer-readable storage medium, or a combination thereof. Moreover, a computer-readable storage medium may be implemented in practice as one or more distinct mediums.

A computer-readable signal medium includes a transitory propagating signal per se. A computer-readable signal medium may include a propagated data signal in baseband or as part of a carrier wave. More specifically, a computer-readable signal medium does not encompass a computer-readable storage medium.

A computer-readable storage medium is a tangible device/hardware that can retain and store a program (instructions) and/or data for use by or in connection with a computer or other processing device set out more fully herein. Notably, a computer-readable storage medium does not encompass a computer-readable signal medium. Thus, a computer readable storage medium, as used herein, is not to be construed as being transitory signals per se, such as radio waves or other freely propagating electromagnetic waves through a transmission media.

A computer-readable storage medium includes computer-readable hardware such as a computer-readable storage device, e.g., memory. Here, a computer-readable storage device and computer-readable hardware are physical, tangible implementations that are non-transitory.

By non-transitory, it is meant that, unlike a transitory propagating signal per se, which will naturally cease to exist, the contents of the computer-readable storage device or computer-readable hardware that define the claimed subject matter persists until acted upon by an external action. For instance, program code loaded into random access memory (RAM) is deemed non-transitory in that the content will persist until acted upon, e.g., by removing power, by overwriting, deleting, modifying, etc.

Moreover, since hardware comprises physical element(s) or component(s) of a corresponding computer system, hardware does not encompass software, per se.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A hybrid manufacturing machine comprising:
a workpiece platform upon which a part is built or repaired;
a powder delivery system; and
a scan head that is configured to emit:
a first energy beam that implements an additive process on the part; and
a second energy beam that implements a material manipulation process on the part;
wherein:
a controller executes a program to perform a manufacturing operation on the part situated on the workpiece platform based upon a three-dimensional representation of the part such that:
the controller controls the powder delivery system to deliver powder from a powder storage system to the workpiece platform;
the controller implements the additive process by controlling the scan head to emit the first energy beam according to the program executed by the controller to selectively melt powder proximate to a top surface of the workpiece platform to add structure to the part; and
the controller implements the material manipulation process by controlling the scan head to emit the second energy beam to manipulate material in the machine.

2. The hybrid manufacturing machine of claim 1 further comprising:
a measurement device;
wherein:
the controller implements the material manipulation process to remove structure from the part based upon an output from the measurement device.

3. The hybrid manufacturing machine of claim 2, wherein:
the measurement device is a three-dimensional surface profilometer.

4. The hybrid manufacturing machine of claim 1, wherein:
the workpiece platform comprises a powder bed over a support plate; and
the powder delivery system delivers powder to the workpiece platform by delivering powder to the powder bed;
further comprising:
a coating mechanism having a spreader that spreads a powder layer delivered to the powder bed by the powder delivery system; and
a measurement device implemented as a profilometer attached to a spreader of the powder delivery system, wherein the controller implements the material manipulation process to remove structure from the part based upon an output from the measurement device.

5. The hybrid manufacturing machine according to claim 1, wherein:
the controller controls the scan head to emit the second energy beam to implement the material manipulation process to manipulate at least one characteristics of the part by re-melting at least a portion of a layer of material.

6. The hybrid manufacturing machine according to claim 1, wherein:
the controller controls the scan head to emit the second energy beam to implement the material manipulation to create a pressure differential directed to manipulate powder in the powder bed without melting the powder.

7. The hybrid manufacturing machine according to claim 1, wherein:
the controller controls the scan head to emit the second energy beam to implement the material manipulation to perform laser peening of at least a portion of the top layer of the part.

8. The hybrid manufacturing machine according to claim 1, wherein:
the controller controls the scan head to emit the second energy beam to implement the material manipulation to modify a surface characteristic of the part to perform at least one of: modify a stress profile of the part without re-melting material, and modifying a surface profile to bond with a next layer of different material.

9. The hybrid manufacturing machine according to claim 1, wherein:
the controller controls the scan head to emit the second energy beam to perform a material property modification to alter at least one material property from at least a portion of the part, the at least one material property selected from grain direction, a stress property, hardness, brittleness, a compressive characteristic, a sheer characteristic, an elastic property, and ductility.

10. The hybrid manufacturing machine of claim 1, wherein the scan head comprises:
a beam expander to control the beam diameter of at least one of the first beam and the second beam such that the first beam has a larger diameter than the second beam.

11. A process of implementing hybrid manufacturing in a single machine, comprising:
repeatedly performing a sequence of machining operations, comprising:
controlling, by a controller, a first energy beam to selectively melt at least one layer of powder to add structure onto a part according to a three-dimensional representation of the part;
determining whether a build manipulation is required; and
controlling, by the controller, a second energy beam to perform a material manipulation when the determination indicates that a build modification is required.

12. The process of claim 11 further comprising:
measuring, by a measurement device, a surface of the part after selectively melting the at least one layer,
wherein:
determining whether a build correction is required comprises determining whether a build correction is required based upon results of measuring by the measurement device.

13. The process of claim 12, wherein controlling, by a controller, a first energy beam to selectively melt at least one layer of powder comprises:
selectively melting a single layer before measuring by the measurement device.

14. The process of claim 13, wherein controlling, by the controller, a second energy beam to perform a material manipulation, comprises:
micro-machining only targeted defects that are detected as a result of comparing the result of measuring by the measurement device to the corresponding layer in the three-dimensional representation.

15. The process of claim 12, wherein determining whether a build correction is required comprises:
comparing a result of measuring by the measurement device to a corresponding layer in the three-dimensional representation of the part; and
determining a that a build correction is required by detecting that the result of the measuring by the measurement device differs from the three-dimensional representation by a predetermined threshold.

16. The process of claim 11, controlling, by the controller, a second energy beam to perform a material manipulation, comprises:
modifying at least one material property from at least a portion of the part, the at least one material property selected from grain direction, a stress property, hardness, brittleness, a compressive characteristic, a sheer characteristic, an elastic property, and ductility.

17. The process of claim 11, wherein controlling, by the controller, a second energy beam to perform a material manipulation, comprises:
performing the micro-machining operation to create a feature size that is finer than what is otherwise possible with the first energy beam alone.

18. The process of claim 11 further comprising:
controlling the second beam to re-melt at least a portion of the powder in a build plane according to a cross-section of the part based upon data from the three-dimensional representation of the part.

19. The process of claim 11 further comprising:
measuring, by a measurement device, a surface of the part after selectively melting the at least one layer by producing a surface map based upon a scan of the surface of the part.

20. The process of claim 19, wherein:
determining whether a build correction is required comprises identifying at least one of a material surface designation and a material property designation in a corresponding layer in the three-dimensional representation of the part; and
controlling, by the controller, a second energy beam to perform at least one of a material property modification and a material surface modification based upon the determined build correction.

21. The process of claim 20, wherein determining whether a build correction is required comprises:
comparing the surface map to a corresponding layer in the three-dimensional representation of the part;
further comprising:
identifying any defects or geometric inaccuracies in the scanned layer; and
identifying edge and surface roughness in the scanned layer.

22. The process of claim 11 further comprising:
measuring, by a measurement device, a surface of the part;
determining whether a build correction is required by identifying areas in the last built layer that require re-melting; and
selectively re-melting the scanned layer based upon the identified areas in the scanned layer that require re-melting.

23. The process of claim 11, wherein the first energy beam and the second energy beam are emitted from the same laser source, the process further comprising:
controlling, by the controller, at least one parameter of the laser source such that the first energy beam has at least one different property compared to the second energy beam.
